(19) United States
(12) Patent Application Publication
(10) Pub. No.: US 2005/0105389 A1
(43) Pub. Date: May 19, 2005

(54) Method and an apparatus for the continuous mixing of two flows

(76) Inventor: Karsten Wilken, Kagerod (SE)

Correspondence Address: BURNS DOANE SWECKER & MATHIS L L P, POST OFFICE BOX 1404, ALEXANDRIA, VA, 22313-1404, US

(21) Appl. No.: 10/493,970

(22) PCT Filed: Oct. 25, 2002
(86) PCT No.: PCT/SE02/01950

(30) Foreign Application Priority Data
Oct. 29, 2001 (SE) 0103591-4

(51) Int. Cl. B01F 7/00

(52) U.S. Cl. 366/279

(57) ABSTRACT

The present invention relates to a method and an apparatus for mixing two flows, a first, larger flow (2) and a second, smaller flow (3). The apparatus includes a T-pipe (4) where an inlet (5) for the first flow (2) and an inlet (6) for the second flow (3) are placed at 180° in relation to each other. The second flow (3) is thereby introduced into the first flow (2) in a direction which is opposed to that of the first flow (2). The T-pipe (4) also displays an outlet (7) for the mixed flows (8). The outlet (7) is placed at 90° in relation to the two inlets (5, 6). The two flows (2, 3) are thereby forced to change direction immediately after the mixing.

### TECHNICAL FIELD

The present invention relates to a method of mixing two flows which consist of a first, larger flow and a second, smaller flow, the second flow being introduced into the first flow in a direction opposite to that of the first flow.

The present invention also relates to an apparatus for the continuous mixing of two flows, the flows consisting of a first, larger flow and a second, smaller flow, and the apparatus including an inlet for the first flow and an inlet for the second flow, as well as a common outlet for the mixed flows.

### BACKGROUND ART

In the manufacture of drinks such as fruit juices, nectar, still drinks (non-carbonated soft drinks) and the like, it is often the intention to mix two or more flows with one another. The different flows very often are of a different nature and may, for example, consist of juice concentrate which is mixed with water or sugar solution which is mixed with a fruit juice, etc. In order to check that the desired mixture has been obtained, the sugar content is measured after the mixing operation. The sugar content is measured in ° Brix with the aid of a refractometer. In order that the Brix value of the product be as reliable as possible, the mixture must be as homogeneous as possible before the product reaches the refractometer.

In most countries, juices and nectar have a mandatory minimum Brix content in order to be sold under each respective name. If there is an insufficient mixture and, as a result, an unreliable Brix value in the subsequent measurement, it must be ensured that there is a margin down to the lowest permitted Brix value, which entails increased raw materials costs.

The mixing may be carried into effect in different ways. One prior art method is batchwise mixing in a tank with agitators, this method being both costly and requiring considerable space. A further method is to cause the mixing to take place in a so-called static mixer where the two flows are caused to pass an apparatus where a number of obliquely inclined plates or disks give rise to turbulence in the flows, which mixes the two flows. However, this method has not proved to be totally reliable.

Yet a further method and an apparatus for mixing two flows is described in Swedish Patent Specification SE 508 137. This method is completely continuous and entails that a small flow is introduced into a larger flow. The introduction of the small flow takes place at a throttle passage of the conduit for the larger flow and in such a manner that the flows are counter-directed. This method gives a good mixture, but for some applications an even further improved mixture is required so that a homogeneous product is rapidly and reliably obtained.

### OBJECT OF THE INVENTION

One object of the present invention is to realise a method and an apparatus which, during continuous mixing, gives as homogeneous a product as possible.

### SOLUTION

This and other objects have been attained according to the present invention in that the method of the type described by way of introduction has been given the characterising feature that both of the flows are caused to change direction immediately after the mixing.

This and other objects have also been attained according to the present invention in that the apparatus of the type described by way of introduction has been given the characterising feature that the apparatus consists of a T-pipe where both inlets are placed at 180° in relation to one another and the outlet is placed at 90° in relation to the inlet.

Preferred embodiments of the present invention have further been given the characterising features as set forth in the appended subclaims.

### BRIEF DESCRIPTION OF THE ACCOMPANYING DRAWING

One preferred embodiment of the present invention will now be described in greater detail hereinbelow, with reference to the accompanying Drawing. In the accompanying Drawing:

FIG. 1 shows, partly in section, a side elevation of the installation.

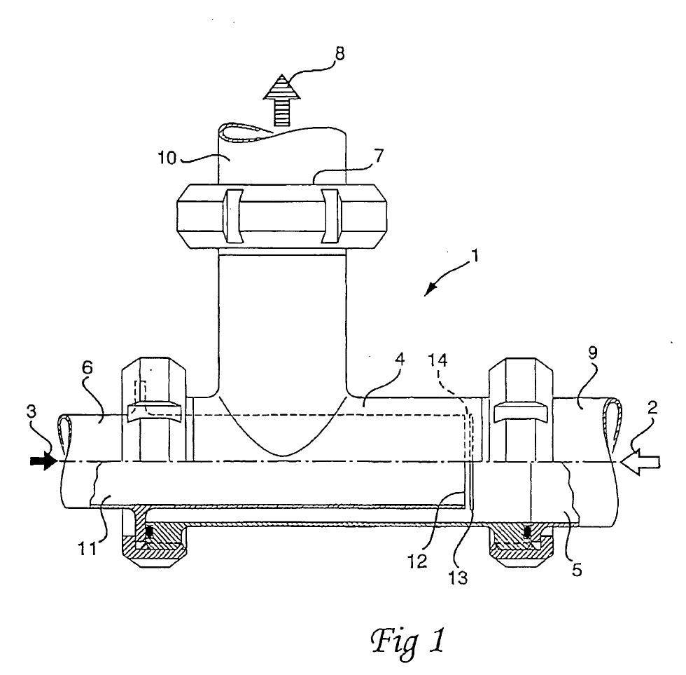

The Drawing shows an apparatus 1 which may be employed for the continuous mixing of two flows, a first, larger flow 2 and a second, smaller flow 3. The flow directions are illustrated on the Drawing by means of arrows.

The apparatus 1 includes a T-pipe 4. One end of the T-pipe 4 consists of an inlet 5 for the first, larger flow 2 and another end of the T-pipe 4 constitutes an inlet 6 for the second, smaller flow 3. Both of these ends of the T-pipe are oriented at 180° in relation to one another so that the two inlets 5, 6 are counter-directed.

The third end of the T-pipe 4 constitutes an outlet 7 for the mixed product 8 which consists of the two flows 2, 3. The outlet 7 is oriented at 90° in relation to the two inlets 5, 6.

The inlet 5 is directly connected to a conduit 9 which encloses the first flow 2. The conduit 9 has the same diameter as the diameter of the T-pipe 4. The outlet 7 is also directly connected to a conduit 10 which encloses the ready-mixed product 8. The conduit 10 also has the same diameter as the T-pipe 4 and thus also the same diameter as the inlet 5.

The inlet 6 is connected to a conduit 11 which is of a diameter which is smaller than the diameter of the T-pipe 4. Thus, the conduit 11 is of a diameter which is also less than that of the conduit 9 for the first flow 2 and the conduit 10 for the finished product 8. The conduit 11 is placed in the T-pipe 4 so that the conduit 11 continues through the T-pipe 4 and has a terminal end 12 just inside the inlet 5. The end of the T-pipe 4 at the inlet 6 is sealed against the conduit 11. The conduit 11 should be centred in the T-pipe 4.

The terminal end 12 of the conduit 11 can be wholly open to the inlet 5. In the preferred embodiment, the terminal end 12 is provided with a round washer 13 which is of a diameter which approximately corresponds to the diameter of the conduit 11. The washer 13 is secured on the terminal end 12 of the conduit 11 so that a gap 14 is formed between the terminal end 12 of the conduit 11 and the washer 13.

The purpose of the gap 14 is to spread the second flow 3 when it meets the first flow 2, which gives a both efficient and rapid mixing of the two flows 2 and 3. The gap 14 is adapted so that it is approx. 3 mm. A larger gap 14 would result in a poorer mixing of the two flows 2, 3 and a smaller gap 14 requires a larger pump capacity in order to transport the second, smaller flow 3. If the second flow 3 is a fruit juice concentrate, the width of the gap 14 should be selected so that any possible fibres and/or fruit flesh pieces in the fruit juice concentrate do not fasten between the terminal end 12 and the washer 13.

The diameter of the conduit 11 should be selected so that it does not constitute more than 60% of the diameter of the conduit 9. If use is made of stainless steel standard tubing, as is normally employed within the dairy industry, this corresponds to a diameter Ø38 mm for the conduit 11 and a diameter Ø51 mm for the conduit 9. Other diameters may also be employed.

The first, larger flow 2 enters into the apparatus in the conduit 9. When the first flow 2 reaches the inlet 5 in the T-pipe 4, it will meet the second, smaller flow 3 which is counter-directed in relation to the first flow 2. The second flow 3 which enters into the apparatus 1 in the conduit 11 is normally pumped into the apparatus by means of a positive/action pump (not shown), so that an excess pressure will be obtained on the second, smaller flow 3.

The second, smaller flow 3 flows out in the first, larger flow 2 through the gap 14 and is mixed with the first flow 2. The first flow 2 with admixture of the second flow 3 continues in the direction of movement of the first flow 2. When it arrives at the inlet 6 which is sealed against the conduit 11 it can no longer continue, but the mixed flow, which constitutes the product 8, is forced to change direction and continue out from the apparatus 1 through the outlet 7. By forcing the mixed product 8 to change direction of movement in the apparatus 1, a more efficient mixing will be obtained and the ready-mixed product 8 which departs from the apparatus in the conduit 10 is homogeneous and well mixed.

The conduit 10 continues thereafter to a refractometer (not shown) and further to other measurement equipment and treatment stations for the product 8.

As will have been apparent from the foregoing description, the present invention realises an apparatus 1 which, in a simple and efficient manner, mixes together two flows to form a homogeneous mixture.

1. A method of mixing two flows, which consist of a first, larger flow (2) and a second, smaller flow (3), the second flow (3) being introduced into the first flow (2) in a direction opposite to that of the first flow (2), characterised in that both flows (2, 3) are caused to change direction immediately after the mixing.

2. An apparatus (1) for the continuous mixing of two flows, which flows consist of a first, larger flow (2) and a second, smaller flow (3), the apparatus (1), comprising an inlet (5) for the first flow (2) and an inlet (6) for the second flow (3), as well as a common outlet (7) for the mixed flows (8), characterised in that the apparatus (1) includes a T-pipe (4) where both of the inlets (5, 6) are placed at 180° in relation to one another and the outlet (7) is placed at 90° in relation to the inlets (5, 6).

3. The apparatus (1) as claimed in claim 2, characterised in that a conduit (11) for the second, smaller flow (3) is of a diameter which is not more than 60% of a diameter of a conduit (9) for the first, larger flow (2).

4. The apparatus (1) as claimed in claim 3, characterised in that the conduit (11) passes straight through the T-pipe (4) of the apparatus (1) so that the conduit (11) has a terminal end (12) immediately inside the inlet (5).

5. The apparatus (1) as claimed in claim 4, characterised in that the terminal end (12) is provided with a washer (13) positioned such that a gap (14) occurs between the terminal end (12) and the washer (13).

6. The apparatus (1) as claimed in claim 5, characterised in that the gap (14) is of a width of approx. 3 mm.
